(19) United States
(12) Patent Application Publication
(10) Pub. No.: US 2014/0118779 A1
(43) Pub. Date: May 1, 2014

(54) IMAGE FORMING APPARATUS AND CONTROL METHOD FOR IMAGE FORMING APPARATUS

(71) Applicant: CANON KABUSHIKI KAISHA, Tokyo (JP)

(72) Inventor: Yoshiharu Ito, Kawasaki-shi (JP)

(73) Assignee: CANON KABUSHIKI KAISHA, Tokyo (JP)

(21) Appl. No.: 14/055,306

(22) Filed: Oct. 16, 2013

(30) Foreign Application Priority Data
Oct. 25, 2012 (JP) 2012-236074

(51) Int. Cl. H04N 1/00

(52) U.S. Cl. CPC H04N 1/00891
USPC 358/1.15

(57) ABSTRACT

An image forming apparatus includes a main storage device, an auxiliary storage device, a receiving unit, and an execution unit configured to execute a program corresponding to a first-type packet by reading the program from the auxiliary storage device to the main storage device to shift the image forming apparatus to a first power state based on the first-type packet in a case where the received network packet is the first-type packet, and execute a program corresponding to a second-type packet by reading the program from the auxiliary storage device to the main storage device to shift the image forming apparatus to a second power state based on the second-type packet in a case where the received network packet is the second-type packet.

### BACKGROUND

1. Field

Aspects of the present invention generally relate to an image forming apparatus, an information processing method, and a program.

2. Description of the Related Art

Conventionally, when an image forming apparatus is in a power saving state, operations such as stopping the power supply for a fixing device, which consumes a larger amount of electricity, and turning off a display of an operation unit of the image forming apparatus have been executed.

In recent years, in order to realize lower power consumption, there has been provided a configuration in which the power is only supplied to a volatile storage device (dynamic random access memory (DRAM)) while stopping the power supply for most of the other parts of the image forming apparatus including a central processing unit (CPU).

On the other hand, as a technique for shortening the activation time of a personal computer, there has been provided a technique known as a hibernation technique.

In the hibernation technique, the information stored in a volatile storage device (memory) of a system at a given point in time is retreated to and stored in a non-volatile storage device such as an HDD, an SSD, and a USB memory. Then, when the system is activated next time, a state of the system is restored to “retreated-stored state” by writing-back the retreated-stored information to the volatile storage device. In addition, the abbreviation “HDD” stands for “hard disk drive”. The abbreviation “SSD” stands for “solid state drive”. The abbreviation “USB” stands for “universal serial bus”.

With the hibernation technique, the power supply for the volatile storage device can also be stopped, and thus the power consumption thereof can be further lowered. However, because the information is exchanged between the volatile storage device and the non-volatile storage device, the access speed of one device (normally, the non-volatile storage device), which is slower than that of the other device, influences the processing speed of the other device.

In these days, this has been a more serious problem because the software that configures a system of the image forming apparatus has been increased in size.

Japanese Patent Application Laid-Open No. 2009-146061 discusses such a kind of problem concerning the hibernation technique.

In order to further lower the power consumption, the above-described hibernation technique may desirably be employed. However, shifting processing for shifting the power state from a normal power state to a low power consumption state, and restoration processing for restoring the power state from the low power consumption state to the normal power state may require time. Accordingly, there is a problem in that the workability of a user of the image forming apparatus may be lowered.

On the other hand, as a technique for shortening the shifting processing time and the restoration processing time, a conventional technique in which the area for supplying power is widened without using the non-volatile storage device may desirably be employed. However, with this technique, there is a problem in that it is difficult to realize the lowering of power consumption.

As described above, achieving both the lowering of power consumption and the shortening of shifting processing time and restoration processing time has been technically difficult.

### SUMMARY OF THE INVENTION

Aspects of the present invention generally relate to providing an image forming apparatus capable of achieving both lowering of power consumption and shortening of shifting processing time and restoration processing time.

According to an aspect of the present invention, an image forming apparatus includes a main storage device, an auxiliary storage device configured to store a plurality of programs having different functions, a receiving unit configured to receive a network packet, and an execution unit configured to execute a program selected, according to a type of the network packet received by the receiving unit, from the plurality of programs stored in the auxiliary storage device by reading out the program from the auxiliary storage device to the main storage device.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image forming apparatus.

FIG. 2 is a block diagram illustrating an example of a hardware configuration of a network interface unit.

FIG. 3 is a table illustrating an example of a correspondence relationship between power states of the image forming apparatus and operation states of a power supply unit.

FIG. 4 is a diagram illustrating a power supply state corresponding to a power state 4 of the image forming apparatus.

FIG. 5 is a diagram illustrating a power supply state corresponding to a power state 1 of the image forming apparatus.

FIG. 6 is a diagram illustrating a power supply state corresponding to a power state 2 of the image forming apparatus.

FIG. 7 is a diagram illustrating a power supply state corresponding to a power state 3 of the image forming apparatus.

FIG. 8 is a diagram illustrating an example of transition between respective power states of the image forming apparatus.

FIG. 9 is a table illustrating an example of a correspondence relationship between the type of the program operating on the image forming apparatus and the constituent element of the image forming apparatus controlled by the program.

FIG. 10 is a flowchart illustrating an example of the information processing for determining whether the power state can be shifted to another power state when the image forming apparatus is in a power state 1.

FIG. 11 is a flowchart illustrating an example of the pre-processing that is to be executed before stopping the power supply for a system 2.

FIG. 12 is a flowchart illustrating an example of the information processing for responding to an inquiry from a host computer connected thereto via a network.

FIG. 13 is a table illustrating an example of comparison pattern information used for repeating the processing performed in steps S602 through S604.

FIG. 14 is a flowchart illustrating details of the processing in step S608 that is to be executed if conformed pattern information is present in the comparing processing of the pattern information executed in step S603.

FIG. 15 is a flowchart illustrating an example of generation processing for generating an image file 2 described as an example in step S804.

### DESCRIPTION OF THE EMBODIMENTS

Exemplary embodiments will be described in detail below with reference to the drawings.

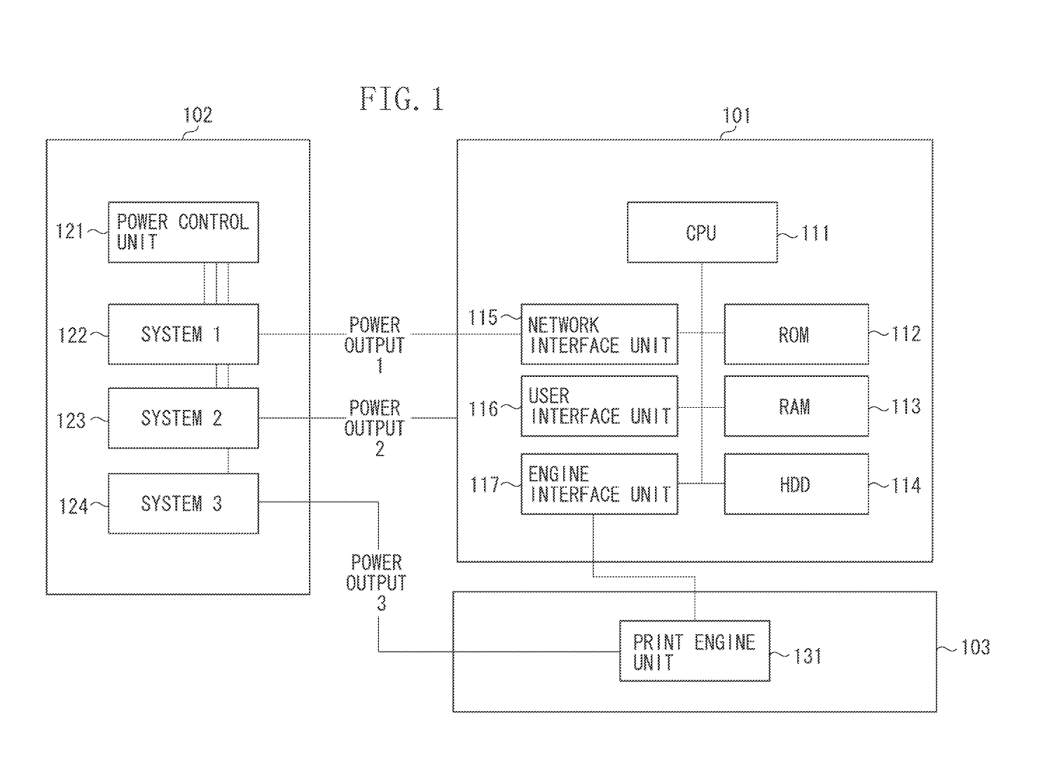

FIG. 1 is a block diagram illustrating an example of a hardware configuration of an image forming apparatus according to an exemplary embodiment. In the present exemplary embodiment, an image forming apparatus only having a printer function will be described as an example. However, the present exemplary embodiment is not limited thereto, and may be applicable to a multifunction image forming apparatus (multifunction peripheral) having a scanner function, a facsimile function and a storage function. Further, although the present exemplary embodiment will be described by using an HDD serving as an auxiliary storage device, another non-volatile storage device may be used therefor.

A main control unit 101 includes a CPU 111 which executes a program, and a read only memory (ROM) 112 and an HDD 114 as non-volatile storage devices. Further, the main control unit 101 includes a random access memory (RAM) 113 as a volatile storage device. The RAM 113 as a main storage device is used for a region where the program stored in the HDD 114 is expanded to an executable format. The RAM 113 is also used for a work region for storing data. A network interface unit 115 is connected to a host computer (not illustrated) to receive print data or an inquiring packet and transmit an answering packet. A user interface unit 116 includes a liquid crystal display which displays a state of the image forming apparatus, and an input key which allows a user to manually operate the image forming apparatus. An engine interface unit 117 communicates with a print engine unit 103. The print engine unit 103 serves as a printing unit which executes printing on a sheet of paper through an electro-photographic method or an ink jet method.

A power supply unit 102 includes power systems 122 through 124, and a power control unit 121 that controls the power systems 122 through 124. The relationship of the power supply unit 102 to the main control unit 101 and the print engine unit 103, and the correlation with the power state of the image forming apparatus will be described below.

The CPU 111 realizes the function of the image forming apparatus in below-described power states 1 and 2, and the processing according to below-described flowcharts by reading out a program stored in the HDD 114 to the RAM 113 to execute the processing based on the program.

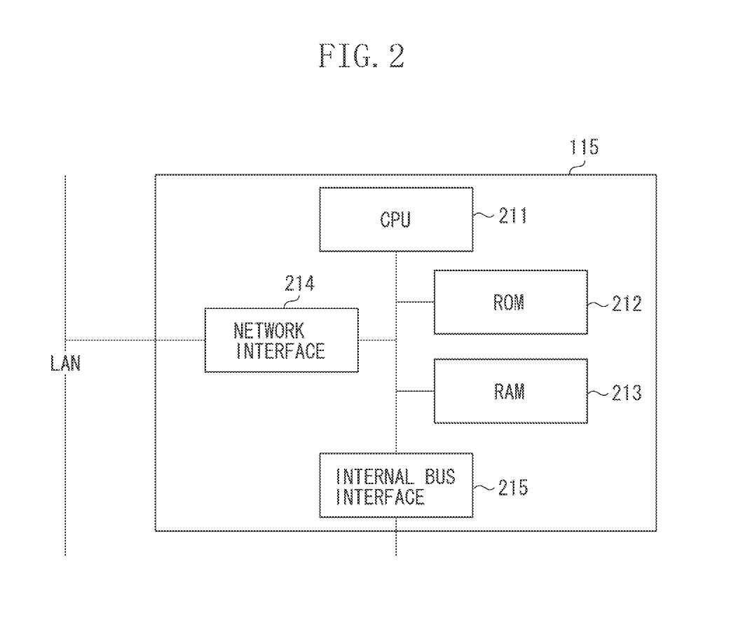

FIG. 2 is a block diagram illustrating an example of a hardware configuration of the network interface unit 115.

The network interface unit 115 includes a CPU 211, a ROM 212 as a non-volatile storage device, a RAM 213 as a volatile storage device, a network interface 214, and an internal bus interface 215. The network interface 214 serves as a physical interface. The network interface 214 is connected to an internal bus of the main control unit 101 via the internal bus interface 215. The CPU 211, the ROM 212, and the RAM 213 do not operate when the image forming apparatus is in a normal power state. The CPU 111 provided in the main control unit 101 performs network communication by directly controlling the network interface 214 serving as a physical interface via the internal bus interface 215. Because a different operation is performed when the image forming apparatus is in a power saving state, descriptions thereof will be given below.

The CPU 211 realizes the function of the image forming apparatus in below-described power state 3, and the processing according to below-described flowcharts by reading out a program stored in the ROM 212 to the RAM 213 to execute the processing based on the program.

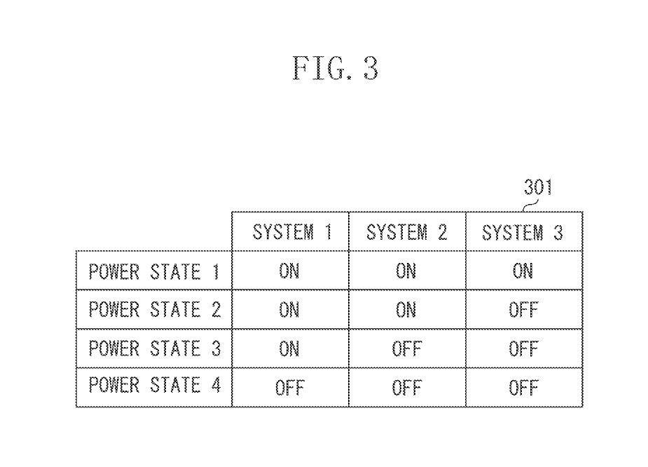

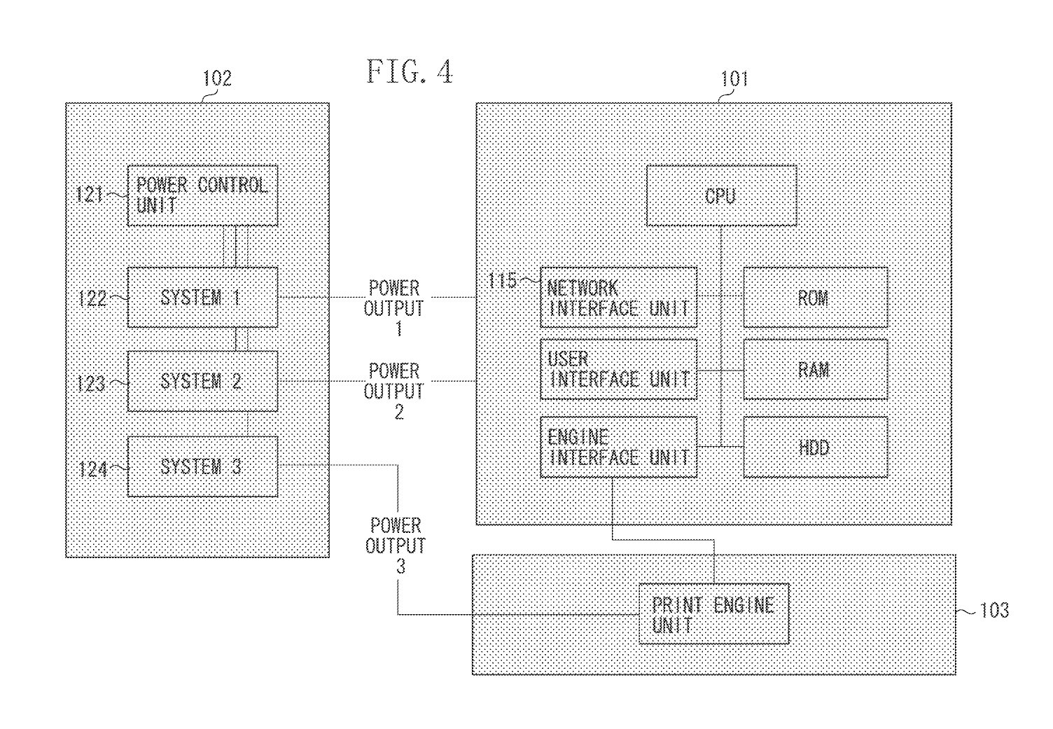

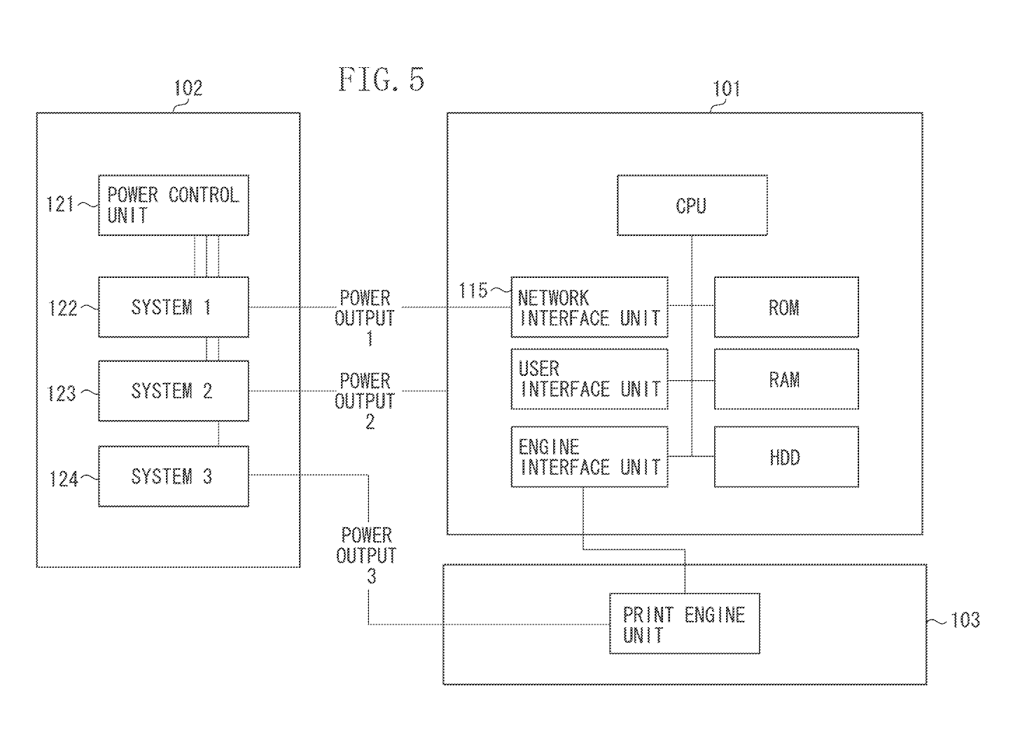

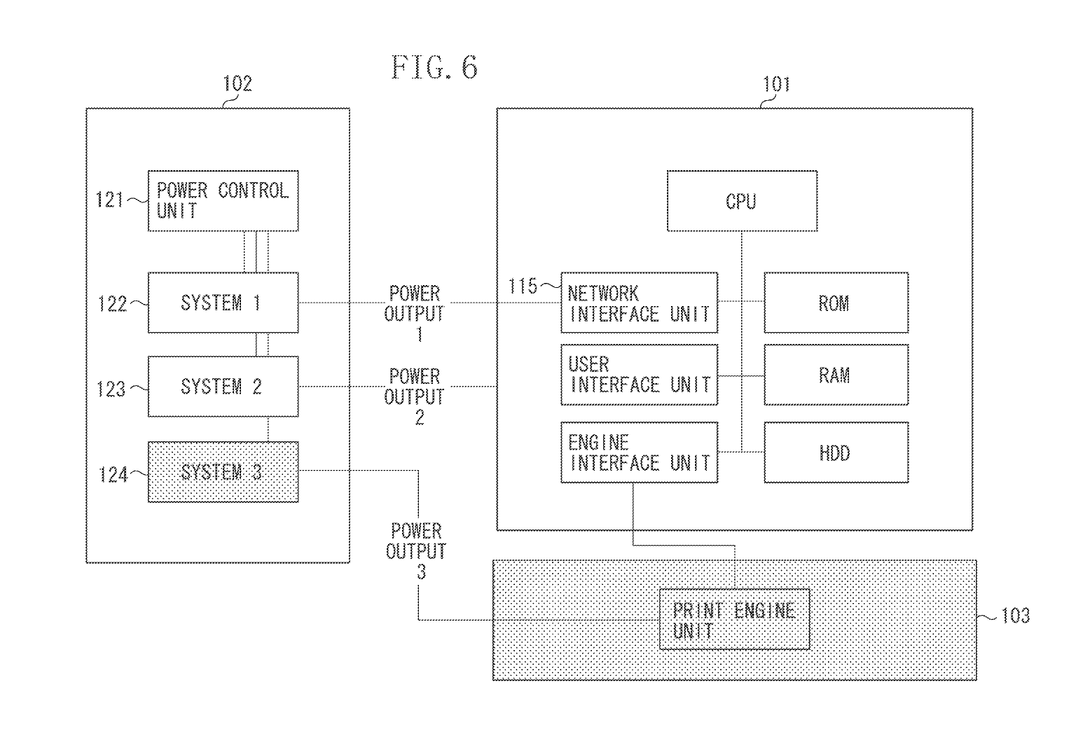

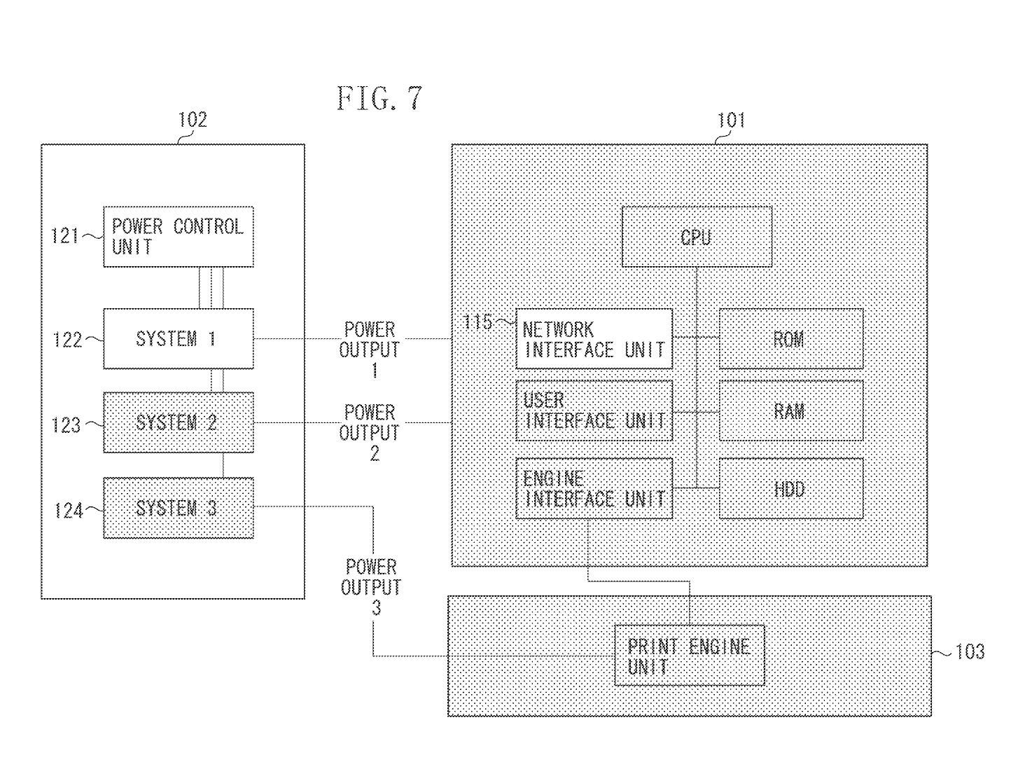

FIG. 3 illustrates a table 301 indicating an example of a correspondence relationship between the power states of the image forming apparatus and the operation states of the power supply unit 102. When the image forming apparatus is in a power state 4, all of systems 1 through 3 are in OFF states where the image forming apparatus does not operate entirely. FIG. 4 is a diagram illustrating an example in which such a state is applied to the configuration of the image forming apparatus. When the image forming apparatus is in a power state 1, all of the systems 1 through 3 are in ON states where all of the functions of the image forming apparatus are operable. FIG. 5 is a diagram illustrating an example in which such a state is applied to the configuration of the image forming apparatus. The power state 2 and the power state 3 are provided between the above-described two power states to serve as the power saving states of the image forming apparatus. In the power state 2, only the system 3 is turned OFF, and thus the power supply for the print engine unit 103 in FIG. 1 is stopped. In the power state 2, although a printing operation cannot be performed on a sheet of paper, the rest of the operations can be performed. For example, in the power state 2, the host computer can acquire the state of the image forming apparatus via the network, or refer to a file within the non-volatile storage device. FIG. 6 is a diagram illustrating an example in which such a state is applied to the configuration of the image forming apparatus. However, the power state 2 is not limited to the example illustrated in FIG. 6, and the power supply for the user interface unit 116, for example, may be stopped as well. In the power state 3, the system 2 is turned OFF in addition to the system 3 so that the power supply for the entire configuration of the main control unit 101 in FIG. 1 except for the network interface unit 115 is stopped. In the power state 3, only the network interface unit 115 operates while most of the processing in the image forming apparatus cannot be operated. FIG. 7 is a diagram illustrating an example in which such a state is applied to the configuration of the image forming apparatus. The operation of the network interface unit 115 in the above-described state will be described below. In the example of the power state 3 illustrated in FIG. 7, the power is only supplied to the network interface unit 115 continuously, while the power supply for the rest of the blocks is stopped. However, for example, in the same manner as in the network interface unit 115, the power may also be supplied to the CPU 211 continuously.

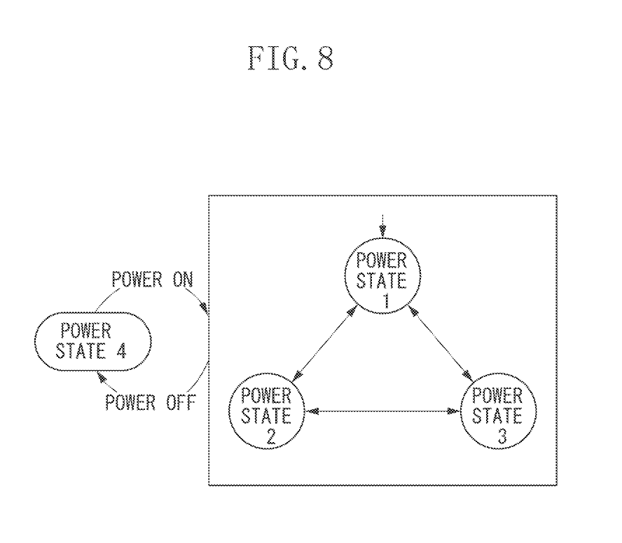

FIG. 8 is a diagram illustrating an example of transition between respective power states of the image forming apparatus. The power supply will be started when a user operates a power switch (not illustrated) in the power state 4 where the power is not supplied to the entire configuration of the image forming apparatus. An initial state immediately after starting the power supply is the power state 1, and the power state thereof will be changed when the shifting condition is evaluated. The power state returns to the power state 4 in a case where the power switch (not illustrated) is operated in any of the power states 1 through 3 to instruct the power supply to be stopped.

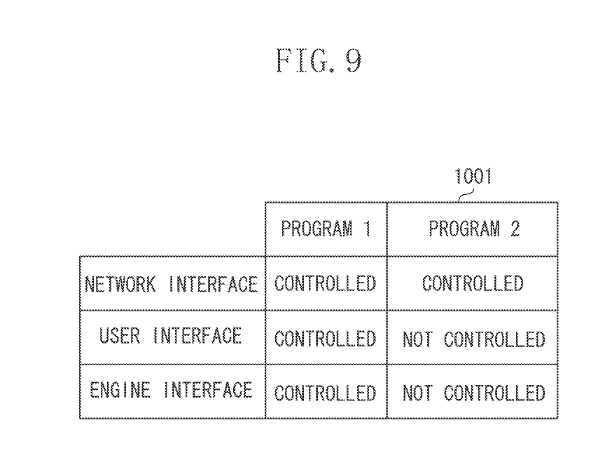

FIG. 9 illustrates a table 1001 indicating an example of a correspondence relationship between the type of the program operating on the image forming apparatus and the constituent element of the device controlled by the program. Although two programs are illustrated in the table 1001, the program may be further divided into three or more programs according to the type and the volume of the constituent element thereof. Further, all of the programs are stored in the HDD 114, transferred to the RAM 113 as necessary, and executed by the CPU 111.

A program 1 relates to the control of the network interface unit 115, the user interface unit 116, and the engine interface unit 117. The program 1 is a program for controlling all of the functions of the image forming apparatus. In the power state 1 illustrated in FIG. 3, it is assumed that the program 1 is operated.

A program 2 only relates to the control of the network interface unit 115, and thus the processing for causing the image forming apparatus to respond to an inquiry provided thereto via the network interface unit 115 will be executed. The program 2 is a program for controlling the image forming apparatus with limited functions. In the power state 3 illustrated in FIG. 3, it is assumed that the program 2 is operated. Because there is the above-described functional difference between the program 1 and the program 2, and because the size of the program is generally smaller if the number of constituent elements as the control target is smaller, the size of the program 2 is smaller when compared to that of the program 1. In the example illustrated in FIG. 9, the user interface unit 116 is not a control target of the program 2. However, the user interface unit 116 may be assigned as the control target thereof.

Next, processing for changing the power state of the image forming apparatus will be described.

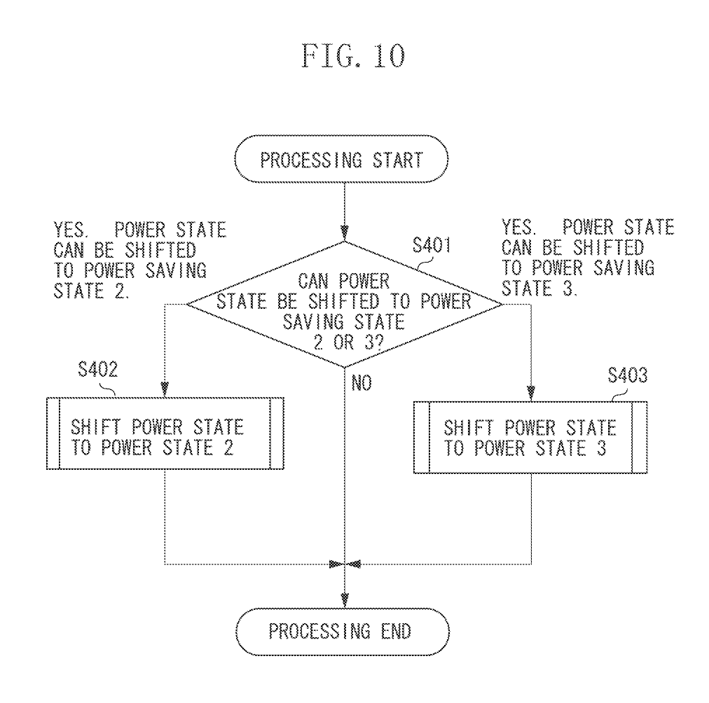

FIG. 10 is a flowchart illustrating an example of information processing for determining whether the power state can be shifted to another power state when the image forming apparatus is in the power state 1. In general, this processing is periodically executed by the image forming apparatus at a certain interval such as once in every minute. The processing illustrated in FIG. 10 will be described based on the configuration in which the CPU included in the power control unit 121 executes the processing based on the program stored in the memory within the power control unit 121. However, in order to make the following description simple, the processing will be described as being executed by the power control unit 121 instead of the CPU included in the power control unit 121.

In step S401, the power control unit 121 makes a determination on the condition whether the image forming apparatus can be shifted to the power saving state. For example, in a case where printing processing is being performed, or the user interface unit 116 has just been operated by a user, the power control unit 121 determines that the image forming apparatus cannot be shifted to the power saving state. The power control unit 121 makes a comprehensive determination such that the power state will not be shifted to the power state 3 in a case where the image forming apparatus is set by a user setting so as not to shift to the power saving state unnecessarily.

In step S401, in a case where the power control unit 121 determines that the power state can be shifted to the power state 2 (YES. POWER STATE CAN BE SHIFTED TO POWER SAVING STATE 2. in step S401), the processing proceeds to step S402. In step S402, the power control unit 121 changes the power state. In step S402, in order to shift the power state to the power state 2, as illustrated in FIGS. 3 and 6, the power control unit 121 executes stopping processing on the system 3 (124) to stop the power supply for the system 3. As a result, the power supply for the print engine unit 103 is stopped, the power state is shifted to the power saving state, and thus the printing processing becomes unavailable.

On the other hand, in step S401, in a case where the power control unit 121 determines that the power state can be shifted to the power state 3 (YES. POWER STATE CAN BE SHIFTED TO POWER SAVING STATE 3. in step S401), the processing proceeds to step S403. In step S403, the power control unit 121 changes the power state. In step S403, in order to shift the power state to the power state 3, as illustrated in FIGS. 3 and 7, the power control unit 121 executes the processing for stopping the power supply for the system 2 and the system 3. However, if the power control unit 121 simply stops the power supply for the system 2, the content stored in the RAM 113 as a volatile storage device will be lost. Therefore, pre-processing that is to be executed before stopping the power supply is required.

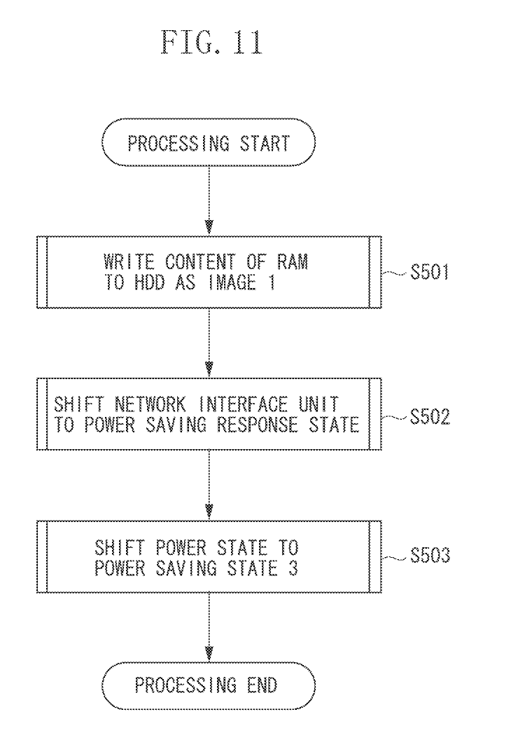

FIG. 11 is a flowchart illustrating an example of the above-described pre-processing that is to be executed before stopping the power supply for the system 2.

In step S501, based on the request from the power control unit 121, the CPU 111 executes the processing for writing the content of the RAM 113 to the HDD 114 as an image file. By executing the above processing, even if the power supply for the RAM 113 is stopped to cause the content to be lost, the state thereof can be restored to the previous state by reading out the content from the HDD 114. Further, because the CPU 111 performs this processing based on the program executed in the power state 1, the image file of the program 1 is stored in the HDD 114. The processing performed in step S501 represents an example of first generation processing.

In step S502, the power control unit 121 shifts the network interface unit 115 to the power saving response state. Through the above processing, the network interface 214 is separated from the control of the CPU 111 to operate independently. Specifically, the CPU 211 in FIG. 2 executes the processing based on the program stored in the ROM 212 to control the network interface 214. The processing that is to be executed based on the program stored in the ROM 212 will be described below.

Next, the description will be given by returning to FIG. 10. In step S403, in order to shift the power state to the power state 3, as illustrated in FIGS. 3 and 7, the power control unit 121 executes the stopping processing on the system 2 (123) and the system 3 (124) to stop the power supply for the system 2 and the system 3. As a result, the power supply for most parts of the main control unit 101 and the print engine unit 103 is stopped, the power state is shifted to the power saving state, and thus most of the processing in the image forming apparatus becomes unavailable.

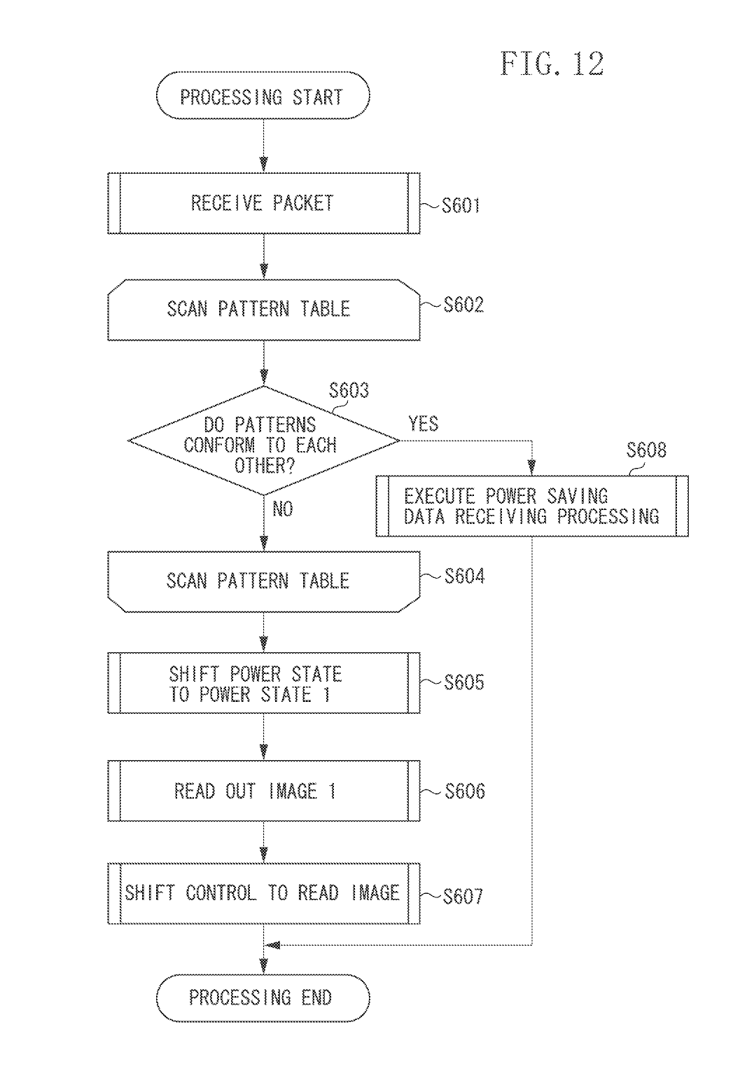

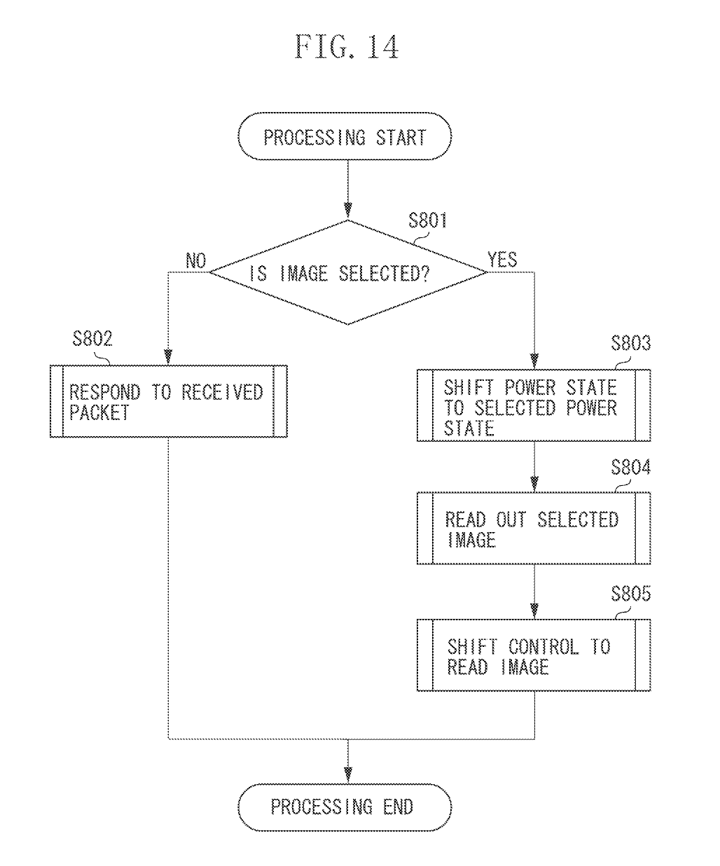

FIGS. 12 and 14 are the flowcharts illustrating the examples of the information processing executed by the network interface unit 115 in the power state 3, as illustrated in FIGS. 3 and 7, for responding to the inquiry from the host computer (not illustrated) connected thereto via the network. This processing is realized when the CPU 211 executes the program stored in the ROM 212 by reading out the program to the RAM 213 and using the RAM 213 as a work memory.

In step S601, the CPU 211 stores the packet received via the network interface 214 in the RAM 213.

By repeating the processing performed in steps S602 through S604, the CPU 211 executes the comparing processing for comparing the previously-received network packet to the pattern information prepared in advance for the comparing processing. Details of the pattern information will be described below.

In step S603, the CPU 211 determines whether the received network packet and the pattern information conform to each other. If the received network packet and the pattern information do not conform to each other (NO in step S603), the CPU 211 stops repeating the processing in steps S602 through S604 to proceed to the processing in step S605.

In step S605, the CPU 211 shifts the power state of the image forming apparatus to the power state 1. With this processing, the power supply for the entire configuration of the image forming apparatus is restarted.

Next, in step S606, in order to allow the image forming apparatus to operate in a normal state hereafter, the CPU 211 executes transfer processing for transferring the image file 1 corresponding to the program 1, which has been previously stored in the non-volatile storage device in step S501, to the RAM 113.

Next, in step S607, the CPU 211 shifts the execution control to the processing based on the image file 1, which has been previously transferred by the transfer processing. Through the above processing, the image forming apparatus can be restored to the state immediately before the execution of the processing illustrated in FIG. 11. In other words, the image forming apparatus is restored to the state before shifting to the power saving state. In a case where there is any conformed pattern information in step S603 (YES in step S603), the CPU 211 proceeds to the processing in step S608. The details thereof will be described below with reference to FIG. 14 because the processing thereof is complicated.

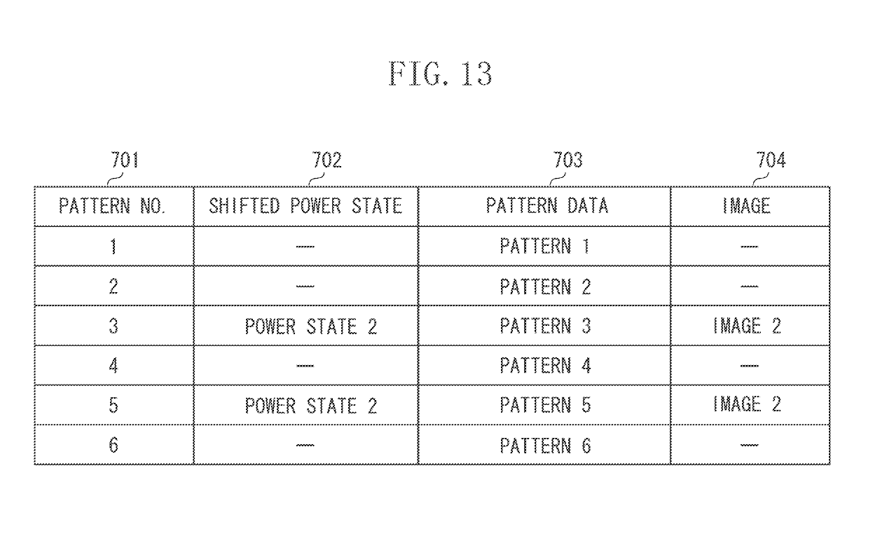

FIG. 13 illustrates a table indicating an example of the comparison pattern information used for repeating the processing performed in steps S602 through S604. The pattern information itself may be stored in the ROM 212 in a non-rewritable state, or may be transferred to the RAM 213 from the HDD 114 via the internal bus interface 215 prior to the processing in step S502 in order to provide general versatility thereto. The pattern information generally includes four kinds of information, each of which will be described in sequence.

A pattern number 701 is a number for uniquely identifying a pattern data 703.

A shifted power state 702 indicates the power state to which the image forming apparatus is shifted when the network packet corresponding to the pattern data 703 is received.

The data used for the comparing processing in step S603 is stored in the pattern data 703.

Image information 704 indicates the image file that is to be transferred to the RAM 213 when the network packet corresponding to the pattern data 703 is received. In this example, either the image file 1 or the image file 2 will be indicated therein as there are only two image files provided. However, because the image file 1 is the image file corresponding to the program 1 for the image forming apparatus which operates normally, the image file 1 is used when the conformed pattern information is not present in the pattern comparing processing. Therefore, in a case where conformed pattern information is present in the pattern comparing processing, either the image file 2 or the information for continuously executing the processing in the power saving state without changing the power state is stored therein.

FIG. 14 is a flowchart illustrating details of the processing in step S608, which is executed if conformed pattern information is present in the comparing processing of the pattern information executed in step S603.

In step S801, the CPU 211 determines whether the image file associated with the conformed pattern information is selected. For example, in a case where the network packet conforming to the pattern number 3 in FIG. 13 is received, the image file 2 is associated therewith. In a case where the network packet conforming to the pattern number 1 is received, the image file is not associated therewith. The processing will be branched subsequently depending on presence or absence of the image file. In a case where the image file is not selected (NO in step S801), the image file that is to be loaded thereon is not present. This indicates that the power state will not be changed.

In step S802, the CPU 211 responds to the network packet received in step S601 without changing the power state. An address resolution protocol (ARP) reply, which notifies another device of an internet protocol (IP) address allocated to a media access control (MAC) address of own device, and an internet control message protocol (ICMP) echo reply, which is used to confirm the presence of own device, can be given as representative examples of the above-described processing.

In step S801, in a case where the CPU 211 determines that the image file is selected (YES in step S801), the processing proceeds to step S803. In step S803, the CPU 211 shifts the power state to the selected power state. For example, in a case where the network packet conforming to the pattern number 3 in FIG. 13 is received, because the power state 2 is selected therefor, the CPU 211 restarts the power supply for the system 2 in order to shift the power state to the power state 2 illustrated in FIGS. 3 and 6.

Next, in step S804, the CPU 211 executes transfer processing for transferring the selected image file to the RAM 113. For example, in a case where the network packet conforming to the pattern number 3 in FIG. 13 is received, because the image file 2 is selected therefor, the CPU 211 transfers the image file 2 to the RAM 113. A method for generating the image file 2 that is to be selected therefor will be described below.

Next, in step S805, the CPU 211 shifts the execution control to the control executed by the CPU 111 based on the image file that has been previously transferred to the RAM 113. The processing similar to the above-described processing is also performed in steps S606 and S607. However, in the above-described processing, it is noticeable that the image file different from that in step S606 or S607 is selectively loaded and executed.

Through the above processing, in a case where the image forming apparatus is in the low power consumption state, the power supply for most parts of the image forming apparatus can be stopped by transferring the content of the volatile storage device to the non-volatile storage device, enabling further lowering of power consumption.

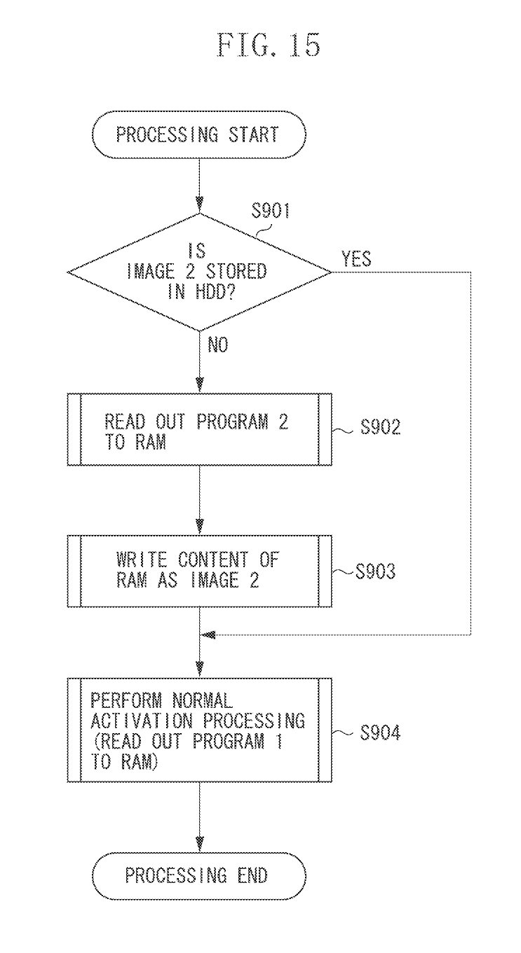

FIG. 15 is a flowchart illustrating an example of the generation processing for generating the image file 2 described as an example in step S804. This processing will be executed every time when the power state has been changed to the power state 1 from the power state 4 where the power of the image forming apparatus is turned OFF.

In step S901, the CPU 111 determines whether the image file 2 corresponding to the program 2 is stored in the HDD 114.

If the image file 2 is stored therein (YES in step S901), the CPU 111 proceeds to the processing in step S904 without executing the processing in some steps. In step S904, the CPU 111 transfers the program 1 stored in the HDD 114 to the RAM 113 to start executing the processing.

In step S901, in a case where the CPU 111 determines that the image file 2 is not stored therein (NO in step S901), the processing proceeds to step S902. In step S902, the CPU 111 transfers the program 2 stored in the HDD 114 to the RAM 113. At this time, although the program 2 becomes executable, the CPU 111 proceeds to the processing in step S903 without executing the program 2. In step S903, the CPU 111 writes the post-transferred content in the RAM 113 to the HDD 114 as the image file 2. Through the above processing, in a case where the image file 2 is not stored in the HDD 114, the image file 2 can be generated. As described above, this image file 2 is used to perform subsequent processing when the network packet of the pattern number 3 in FIG. 13 is received. The processing performed in step S903 represents an example of second generation processing.

In addition, as illustrated in FIG. 9, the number of interfaces as control targets of the program 2 is less than that of the program 1, and thus it is expected that the size of the program 2 is smaller than that of the program 1. Therefore, the image file 2 is smaller in size compared to the image file 1.

Through the above-described processing, with respect to the inquiry from the network device, the image forming apparatus responds to the inquiry while remaining in the power saving state or selects a program image in a different size, according to the type of the packet thereof, thereby optimizing the transfer processing of the information exchanged between the non-volatile storage device and the volatile storage device. Accordingly, the processing speed thereof can be improved.

In the above-described exemplary embodiment, the processing using the image file (i.e., hibernation data) has been described. However, the following configuration, for example, is also possible in another exemplary embodiment. The CPU 211 receives the network packet to determine whether to cause the entire or a part of the image forming apparatus to wake up according to the type of the received network packet. Then, in a case where the CPU 211 determines to cause the entire image forming apparatus to wake up, the CPU 211 selects the program for operating the entire image forming apparatus from the ROM 212. In a case where the CPU 211 determines to cause a part of the image forming apparatus to wake up, the CPU 211 selects the program for operating a part of the image forming apparatus from the ROM 212. Then, the CPU 211 may read out the selected program from the auxiliary storage device such as the ROM 212 to the main storage device such as the RAM 113, so as to cause the CPU 111 to execute the program. In addition, according to the type of the received network packet, the CPU 211 may determine whether it is possible to respond in the power saving state. In a case where the CPU 211 determines that it is possible to respond in the power saving state, the CPU 211 may cause the image forming apparatus to respond in the power saving state.

Further, the CPU 111 may select the program that is to be stored in the ROM 211 from the HDD 114 to store the program in the ROM 212 when the power state is shifted to the power saving state.

Embodiments of the present disclosure can also be realized by a computer of a system or apparatus that reads out and executes computer executable instructions recorded on a storage medium (e.g., computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

As described above, according to each of the above-described embodiments, in a case where the image forming apparatus is in the low power consumption state, the power supply for most parts of the image forming apparatus can be stopped by transferring the content of the volatile storage device to the non-volatile storage device, enabling further lowering of the power consumption. In addition, with respect to the inquiry from the network device, the image forming apparatus may respond to the inquiry while remaining in the power saving state, or may select a program image in a different size, according to the type of the packet. Through the above-described operation, the processing speed thereof can be improved by optimizing the transfer processing of the information exchanged between the non-volatile storage device and the volatile storage device.

With the above processing, the lowering of the power consumption and the acceleration of the processing speed can be realized in a balanced manner, remarkably improving the convenience of a user.

In other words, according to each of the above-described embodiments, it is possible to achieve both the lowering of the power consumption and the shortening of the shifting processing time and the restoration processing time.

According to the exemplary embodiments, it is possible to achieve both the lowering of the power consumption and the shortening of the shifting processing time and the restoration processing time.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application No. 2012-236074 filed Oct. 25, 2012, which is hereby incorporated by reference herein in its entirety.

What is claimed is:

1. An image forming apparatus comprising:
a main storage device;
an auxiliary storage device configured to store a plurality of programs having different functions;
a receiving unit configured to receive a network packet; and
an execution unit configured to execute a program corresponding to a first-type packet by reading the program from the auxiliary storage device to the main storage device to shift the image forming apparatus to a first power state based on the first-type packet in a case where the received network packet is the first-type packet, and to execute a program corresponding to a second-type packet by reading the program from the auxiliary storage device to the main storage device to shift the image forming apparatus to a second power state based on the second-type packet in a case where the received network packet is the second-type packet.

2. The image forming apparatus according to claim 1, further comprising a printing unit configured to print an image on a sheet,
wherein at least the printing unit is supplied with power when the image forming apparatus is in the first power state, and
wherein at least the printing unit not supplied with power when the image forming apparatus is in the second power state.

3. The image forming apparatus according to claim 2, wherein the program corresponding to the first-type packet is a program that operates the printing unit, and
wherein the program corresponding to the second-type packet is a program that does not operate the printing unit.

4. The image forming apparatus according to claim 1, wherein the first program is larger in data size than the second program.

5. The image forming apparatus according to claim 1, wherein the receiving unit receives the first-type or the second-type packet when the image forming apparatus is in a third power state where power supply at least for the main storage device and the auxiliary storage device is stopped.

6. The image forming apparatus according to claim 1, wherein the auxiliary storage device is a non-volatile memory.

7. An image forming apparatus comprising:
a main storage device;
an auxiliary storage device configured to store a plurality of pieces of hibernation data having different functions;
a receiving unit configured to receive a network packet; and
an execution unit configured to execute hibernation data corresponding to a first-type packet by reading the hibernation data from the auxiliary storage device to the main storage device to shift the image forming apparatus to a first power state based on the first-type packet in a case where the received network packet is the first-type packet, and to execute hibernation data corresponding to a second-type packet by reading the hibernation data from the auxiliary storage device to the main storage device to shift the image forming apparatus to a second power state based on the second-type packet in a case where the received network packet is the second-type packet.

8. The image forming apparatus according to claim 7, further comprising a printing unit configured to print an image on a sheet,
wherein at least the printing unit is supplied with power when the image forming apparatus is in the first power state, and
wherein at least the printing unit is not supplied with power when the image forming apparatus is in the second power state.

9. The image forming apparatus according to claim 8, wherein the hibernation data corresponding to the first-type packet is hibernation data that operates the printing unit, and
wherein the hibernation data corresponding to the second-type packet is hibernation data that does not operate the printing unit.

10. The image forming apparatus according to claim 7, wherein the first hibernation data is larger in data size than the second hibernation data.

11. The image forming apparatus according to claim 7, wherein the receiving unit receives the first-type or the second-type packet when the image forming apparatus is in a third power state where power supply at least for the main storage device and the auxiliary storage device is stopped.

12. The image forming apparatus according to claim 7, wherein the auxiliary storage device is a non-volatile memory.

13. A method for controlling an image forming apparatus including a main storage device and an auxiliary storage device, the method comprising:
receiving a network packet;
executing a program corresponding to a first-type packet from among a plurality of programs having different functions stored in the auxiliary storage device by reading the program from the auxiliary storage device to the main storage device to shift the image forming apparatus to a first power state based on the first-type packet in a case where the received network packet is the first-type packet; and
executing a program corresponding to a second-type packet from among the plurality of programs having different functions stored in the auxiliary storage device by reading the program from the auxiliary storage device to the main storage device to shift the image forming apparatus to a second power state based on the second-type packet in a case where the received network packet is the second-type packet.

14. A method for controlling an image forming apparatus including a main storage device and an auxiliary storage device, the control method comprising:
receiving a network packet;
executing hibernation data corresponding to a first-type packet from among a plurality of pieces of hibernation data having different functions stored in the auxiliary storage device by reading the hibernation data from the auxiliary storage device to the main storage device to shift the image forming apparatus to a first power state based on the first-type packet in a case where the received network packet is the first-type packet; and
executing hibernation data corresponding to a second-type packet from among the plurality of pieces of hibernation data having different functions stored in the auxiliary storage device by reading the hibernation data from the auxiliary storage device to the main storage device to shift the image forming apparatus to a second power state based on the second-type packet in a case where the received network packet is the second-type packet.
